(19) United States
(12) Patent Application Publication
(10) Pub. No.: US 2018/0195971 A1
(43) Pub. Date: Jul. 12, 2018

(54) Apparatus and Method for 3D Surface Inspection

(71) Applicant: SHANGHAI MICRO ELECTRONICS EQUIPMENT CO., LTD., SHANGHAI (CN)

(72) Inventors: Fan Wang, Shanghai (CN); Pengli Zhang, Shanghai (CN)

(21) Appl. No.: 15/403,581

(22) Filed: Jan. 11, 2017

(51) Int. Cl. G01N 21/88; G01B 11/30; G01B 9/02; G01N 21/95

(52) U.S. Cl. CPC G01N 21/8806; G01N 21/9501; G01B 9/02011; G01B 11/303

(57) ABSTRACT

3D surface inspection apparatus and method are disclosed. The apparatus includes, disposed sequentially, an illumination unit, a polarization splitting unit, a multi-beam splitter, a plurality of phase-shift plates, a polarization combiner and a detector. A light beam from the illumination unit is split by the polarization splitting unit into an inspection beam and a reference beam that are polarized in directions perpendicular to each other. The inspection beam is superimposed with the reference beam, and the superimposition is divided by the multi-beam splitter into a plurality of sub-beams each of which then passes through a corresponding phase-shift plate for generating an additional phase difference between an inspection sub-beam and a reference sub-beam contained in the corresponding sub-beam, so that a plurality of interference signals are generated at the detector surface. The additional phase differences created by the plurality of phase-shift plates are different from one another.

### TECHNICAL FIELD

The present invention relates to apparatuses and methods for 3D surface inspection.

### BACKGROUND

Super Moore's law and other concepts have led the transformation of the integrated circuit (IC) industry from an era where higher process nodes are pursued to a brand new era where it more relies on chip packaging techniques. Wafer Level Packaging (WLP) is notably advantageous over traditional packaging in package size miniaturization and process cost reduction. Therefore, WLP is considered as one of the critical technologies that support the continuous development of the IC industry.

WLP includes majorly a number of processes such as Gold Pillar Solder Bump, RDL and TSV. In order to achieve a higher yield of chip fabrication, defect inspection needs to be performed throughout the packaging process. Earlier apparatus for this purpose focused on the detection of two-dimensional (2D) surface defects like contaminants, scratches and particles. With higher requirements being imposed on process control, there is an increasing demand for inspection of three-dimensional (3D) surface features such as bump height, RDL thickness and TSV hole depth.

In the current state of the art, there are several methods for 3D surface measurement including those commonly used such as laser triangulation, laser confocal and interferometry. Laser triangulation can employ laser line scanning which enables a higher detection speed but is inferior in accuracy. Although laser confocal and interferometry can both provide higher vertical resolutions, their involvement of vertical scanning leads to low efficiency, making them less desirable for whole full-wafer scanning inspection.

### SUMMARY OF THE INVENTION

The present invention addresses the above-described problems existing in the prior art by presenting a 3D surface inspection apparatus and method.

To this end, a 3D surface inspection apparatus according to the present invention includes, disposed sequentially along a direction of propagation of a light beam, an illumination unit, a polarization splitting unit, a multi-beam splitter, a plurality of phase-shift plates, a polarization combiner and a detector. The light beam from the illumination unit is split by the polarization splitting unit into an inspection beam and a reference beam that are polarized in directions perpendicular to each other. The inspection beam is incident on and reflected by a surface of a target object and enters the polarization splitting unit again. The reference beam is incident on and reflected by a first reflector of the polarization splitting unit and enters the polarization splitting unit again where the reference beam reflected from the first reflector is superimposed with the inspection beam reflected from the surface of the target object. The superimposed inspection beam and reference beam is divided by the multi-beam splitter into a plurality of sub-beams each of which then passes through a corresponding one of the plurality of phase-shift plates and thereby obtains an additional phase difference between an inspection sub-beam and a reference sub-beam contained in the sub-beam. Thereafter, the plurality of sub-beams pass through the polarization combiner, making the inspection sub-beam and the reference sub-beam contained in each of the plurality of sub-beams polarized in a same direction and generating a corresponding interference signal at a surface of the detector. The additional phase differences created by the plurality of phase-shift plates are different from one another.

Preferably, the illumination unit includes, disposed sequentially a light source, a beam collimator/expander and a second reflector. The light beam from the light source passes through the beam collimator/expander and is incident on and reflected by the second reflector; and the light beam reflected from the second reflector is incident on the polarization splitting unit.

Preferably, the light source is a mercury lamp, a xenon lamp, a halogen lamp or a laser light source.

Preferably, the beam collimator/expander includes, disposed sequentially, a first lens and a second lens.

Preferably, the polarization splitting unit further includes a polarization splitter, a first λ/4 plate, a third lens, a second λ/4 plate, a fourth lens and a fifth lens; the light beam from the illumination unit is split by the polarization splitting unit into the inspection beam and the reference beam that are polarized in directions perpendicular to each other; the inspection beam passes through the first λ/4 plate and the third lens and is incident on and reflected by the surface of the target object, and the inspection beam reflected from the surface of the target object passes again through the third lens and the first λ/4 plate with a polarization direction thereof rotated by 90 degrees and further through the polarization splitter and the fifth lens, and is incident on the multi-beam splitter; and the reference beam passes through the second λ/4 plate and the fourth lens and is incident on and reflected by the first reflector, and the reference beam reflected from the first reflector again passes through the fourth lens and the second λ/4 plate with a polarization direction thereof rotated by 90 degrees and is then reflected by the polarization splitter, passes through the fifth lens and enters the multi-beam splitter.

Preferably, a plurality of interference objectives of different magnifications are disposed between the illumination unit and the surface of the target object.

Preferably, the plurality of interference objectives are switchable by a revolving nosepiece.

Preferably, the light beam from the illumination unit passes through the polarization splitting unit and is incident on one of the plurality of interference objectives, and the polarization splitting unit is implemented as a first splitter.

Preferably, the multi-beam splitter includes diffraction optical elements for forming a plurality of planar or stripe-like interference patterns at the surface of the detector

Preferably, the multi-beam splitter includes n second splitters which split the superimposed inspection beam and reference beam into (n+1) sub-beams each of which passes through a corresponding one of the plurality of phase-shift plates and a corresponding polarization combiner and is incident on a corresponding detector, where n is a positive integer.

Preferably, the detector is a CMOS sensor or a CCD sensor.

Preferably, the multi-beam splitter includes a spatial light modulator.

The present invention also provide a 3D surface inspection method using the 3D surface inspection apparatus as defined above, in which a height of any location of the surface of a target object relative to a reference plane is calculated based on a plurality of interference signals simultaneously generated at the surface of the detector for the location.

Preferably, the height h relative to the reference plane is calculated according to:

$$h = \frac{ϕ}{2 π} λ$$

where, λ represents a wavelength of the light beam from the illumination unit, and φ denotes the phase difference between the inspection beam and the reference beam.

Preferably, the superimposed inspection beam and reference beam is divided into four sub-beams, and the phase difference φ is calculated as:

$$ϕ = a c tan ( \frac{{I}_{4} - {I}_{2}}{{I}_{1} - {I}_{3}} )$$

where, I₁, I₂, I₃ and I₄ respectively represent intensities of the interference signals generated by the four sub-beams at the surface of the detector.

Preferably, four phase-shift plates are used to create an additional phase difference of 0, π/2, π and 3π/2 for the four sub-beams, respectively; and I₁, I₂, I₃ and I₄ are calculated as:

I₁=A+B×cos(φ)

I₂=A+B×cos(φ+π/2)

I₃=A+B×cos(φ+π)

I₄=A+B×cos(φ+3π/2)

where, A and B are constants.

Compared to the prior art, the 3D surface inspection apparatus and method according to the present invention enable transient acquisition of plurality of interference signals of a surface location of a target object without involving vertical scanning, from which height information of the target object surface in the field of view can be calculated. This, together with the scanning performed by a motion stage, allows rapid 3D surface inspection with higher efficiency even when the target object is large.

### BRIEF DESCRIPTION OF THE DRAWINGS

FIG. 1 is a schematic illustration of a 3D surface inspection apparatus in accordance with a first embodiment of the present invention.

FIG. 2 schematically illustrates interference signals for four locations being inspected in accordance with the first embodiment of the present invention.

FIGS. 3a to 3d show interference patterns corresponding to the four locations of FIG. 2 at the surface of a detector.

FIG. 4 is a schematic illustration of a multi-beam splitter in accordance with a second embodiment of the present invention.

FIG. 5 schematically illustrates a linear light source and a corresponding detector in accordance with a third embodiment of the present invention.

FIG. 6 shows interference patterns at the detector and a calculated surface height profile in accordance with the third embodiment of the present invention.

FIG. 7 is a schematic illustration of a spatial light modulator in accordance with a fourth embodiment of the present invention.

FIG. 8 is a schematic illustration of a 3D surface inspection apparatus in accordance with a fifth embodiment of the present invention.

In these figures: 10—illumination unit; 11—light source; 12—first lens; 13—second lens; 14—first reflector; 20—polarization splitting unit; 21—polarization splitter; 22—first quarter-λ plate; 23—third lens; 24—second quarter-λ plate; 25—fourth lens; 26—second reflector; 27—fifth lens; 28—first splitter; 29—revolving nosepiece; 29a, 29b and 29c—interference objectives; 30—multi-beam splitter; 31a, 31b, 31c and 31d—second splitters; 40a, 40b, 40c and 40d—phase-shift plates, 41, 41a, 41b, 41c and 41d—polarization combiners; 50, 50a, 50b, 50c and 50d—detectors; 60—target object; 61—motion stage; 70—inspection field of view; 100—incident light beam; 101—inspection beam; 102—reference beam; and 103—outgoing light beam.

### DETAILED DESCRIPTION

In order to more fully describe the subject matter of the present invention, several particular embodiments are listed below for demonstration of its technical effects. It is noted that these embodiments are provided for illustration only, without limiting the scope of the invention in any way.

### Embodiment 1

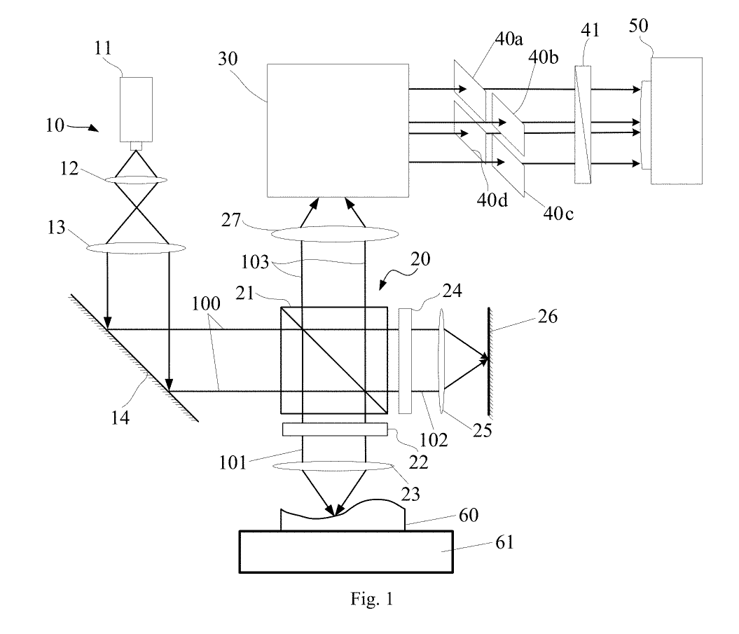

Referring to FIG. 1, a 3D surface inspection apparatus according to the present invention includes, disposed sequentially along the direction of propagation of a light beam, an illumination unit 10, a polarization splitting unit 20, a multi-beam splitter 30, a plurality of phase-shift plates 40a, 40b, 40c, 40d and a detector 50. An inspection beam 101 and a reference beam 102 are formed after the light beam 100 from the illumination unit 10 passes through the polarization splitting unit 20. The inspection beam 101 is incident on the surface of a target object 60 and is reflected by the surface of the target object 60. The reflected inspection beam then again enters the polarization splitting unit 20. The reference beam 102 is incident on the second reflector 26 and is reflected thereby back into the polarization splitting unit 20 where the reference beam reflected from the second reflector 26 is superimposed with the inspection beam 101 reflected from the surface of the target object 60, i.e., coincidence of the reference and inspection optical paths. The light beam 103 (i.e., the superimposed inspection beam 101 and reference beam 102) exiting the polarization splitting unit 20 is divided by the multi-beam splitter 30 into a number of sub-beams (four in this Embodiment). Each sub-beam contains an inspection sub-beam and a reference sub-beam which are polarized perpendicular to each other. After each sub-beam passes a corresponding one of the phase-shift plates 40a, 40b, 40c, 40d, an additional phase difference is created between the inspection sub-beam and the reference sub-beam contained in the sub-beam. Thereafter, the sub-beams pass through a polarization combiner 41, making the inspection sub-beams and the reference sub-beams polarized in the same direction and generating interference signals at the surface of the detector 50. The additional phase differences created by the phase-shift plates 40a, 40b, 40c, 40d are different from one another. According to the present invention, transient acquisition of a plurality of interference signals of a surface location of the target object 60 is made possible without involving vertical scanning by splitting an interference signal into multiple signals using the multi-beam splitter 30 and creating phase differences between them by the phase-shift plates. The signals can be used for computational acquisition of height information of the target object 60 in the field of view, which, together with scanning performed by a motion stage 61, allows rapid 3D surface inspection for the target object 60 with higher efficiency even when it is a large-sized object.

Preferably, with continued reference to FIG. 1, the illumination unit includes, disposed sequentially, a light source 11, a beam collimator/expander and a first reflector 14. The beam collimator/expander includes, disposed sequentially, a first lens 12 and a second lens 13 and is configured to collimate and expand the light beam from the light source 11. After leaving the beam collimator/expander, the light beam is incident on the first reflector 14 and is reflected thereby so that the reflected light beam enters the polarization splitting unit 20. Preferably, the light source 11 may be a monochromatic light source such as a semiconductor laser, a fiber laser or a gas laser. Alternatively, a wide-band white-light source may also be used such as a mercury lamp, a xenon lamp or a halogen lamp. The wide-band white-light source is more preferred because it can expand the range of height measurement for the surface of the target object 60. Wavelength of the light beam from the light source 11 is denoted by 2.

Preferably, with continued reference to FIG. 1, the polarization splitting unit 20 further includes a polarization splitter 21, a first λ/4 plate 22, a third lens 23, a second λ/4 plate 24, a fourth lens 25 and a fifth lens 27 in additional to the second reflector 26. The inspection beam 101 and the reference beam 102 polarized perpendicular to each other are formed after the light beam 100 from the illumination unit 10 passes through the polarization splitting unit 20. The inspection beam 101 passes through the first λ/4 plate 22 and the third lens 23 and is then incident on the surface of the target object 60 that is placed on the motion stage 61. After being reflected by the surface of the target object 60, the inspection beam 101 passes again through the first λ/4 plate 22 with its direction of polarization being rotated thereby by 90 degrees. Afterward, the inspection beam 101 further passes through the polarization splitter 21 as well as the fifth lens 27 and is incident on the multi-beam splitter 30. On the other hand, the reference beam 102 propagates through the second λ/4 plate 24 and the fourth lens 25 and is then incident on and reflected by the second reflector 26. The reference beam 102 reflected from the second reflector 26 passes again through the fourth lens 25 and the second λ/4 plate 24 and is thereby rotated in direction of polarization by 90 degrees. After that, the reference beam 102 is further reflected by the polarization splitter 21 and passes through the fifth lens 27. After leaving the fifth lens 27, the reference beam 102 is incident on the multi-beam splitter 30. This enables the spatial superimposition of the inspection beam 101 and the reference beam 102 to form the light beam 103. The polarization splitter 21 is spaced apart from the second reflector 26 by a fixed distance, whereas the distance between the polarization splitter 21 and a surface location of the target object 60 varies with the height at the location. Therefore, the superimpositions of the reference beam 102 and the inspection beams 101 reflected from different locations of the surface of the target object 60 are associated with distinct phase differences which are in direct relation to the respective heights at the locations and are represented by different light intensities at the detector 50. In other words, such light intensity information is indicative of the heights at the locations of the surface of the target object 60. In order to extract the information about the heights at the locations of the surface of the target object 60, the light beam 103 needs to enter the multi-beam splitter 30.

Preferably, with continued reference to FIG. 1, in this Embodiment, the multi-beam splitter 30 is capable of outputting multiple sub-beams by using diffraction optical elements (DOEs), and the number of the sub-beams is four in this Embodiment. The four sub-beams pass through the respective corresponding phase-shift plates 40a, 40b, 40c, 40d each of which creates a particular phase difference between the inspection sub-beam and the reference sub-beam whose directions of polarization are perpendicular to each other. For example, the additional phase differences created by the plates 40a, 40b, 40c, 40d are 0, π/2, π and 3π/2, respectively. The polarization combiner 41 disposed downstream to the phase-shift plates 40a, 40b, 40c, 40d can align the inspection sub-beam with the reference sub-beam in terms of direction of polarization, allowing their interference at the surface of the detector 50.

The present invention also provides a 3D surface inspection method in which the inspection beam 101 and the reference beam 102 are formed after the light beam 100 from the illumination unit 10 passes through the polarization splitting unit 20. The inspection beam 101 and the reference beam 102 are then superimposed with each other and divided by the multi-beam splitter 30 into multiple sub-beams each of which then passes through a corresponding one of the phase-shift plates 40a, 40b, 40c, 40d and thereby obtains an additional phase difference so that interference signals are generated at the surface of the detector 50, wherein the additional phase differences created by the phase-shift plates 40a, 40b, 40c, 40d are different from one another. The height of any location on surface of the object 60 being inspected compared to a reference plane is calculated based on the plurality of interference signals (four in this Embodiment) generated at the surface of the detector 50.

Specifically, the phase differences enabled by the phase-shift plates 40a, 40b, 40c, 40d can be designed according to practical needs. In this Embodiment, with these additional phase differences being Φₐ=0, Φ_{b}=π/2, Φ_{c}=π and Φ_{d}=3π/2 as an instance, the four interference signals respectively generated from the four sub-beams due to interference can be expressed in a simple form as (for the sake of description, only interference of monochromatic light beams is considered here):

I₁=A+B×cos(φ)

I₂=A+B×cos(φ+π/2)

I₃=A+B×cos(φ+π)

I₄=A+B×cos(φ+3π/2)

In these equations, A and B are constants to be determined,

$$ϕ = \frac{2 π}{λ} h$$

represents the phase difference between the inspection beam 101 and reference beam 102 which form the light beam 103, and h denotes the height of the surface of the target object 60 relative to a reference plane whose height is defined to be zero. The reference plane is selected as an imaginary plane which is on the same side of the splitter 21 as the target object 60 and is spaced from the polarization splitter 21 by a distance that is the same as the distance from the second reflector 26 to the polarization splitter 21. As such, with the additional phase differences created by the phase-shift plates 40a, 40b, 40c, 40d being respectively 0, π/2, π and 3π/2, the phase difference φ between the inspection and reference beams are calculated as:

$$ϕ = a c tan ( \frac{{I}_{4} - {I}_{2}}{{I}_{1} - {I}_{3}} ) \qquad ( 2 )$$

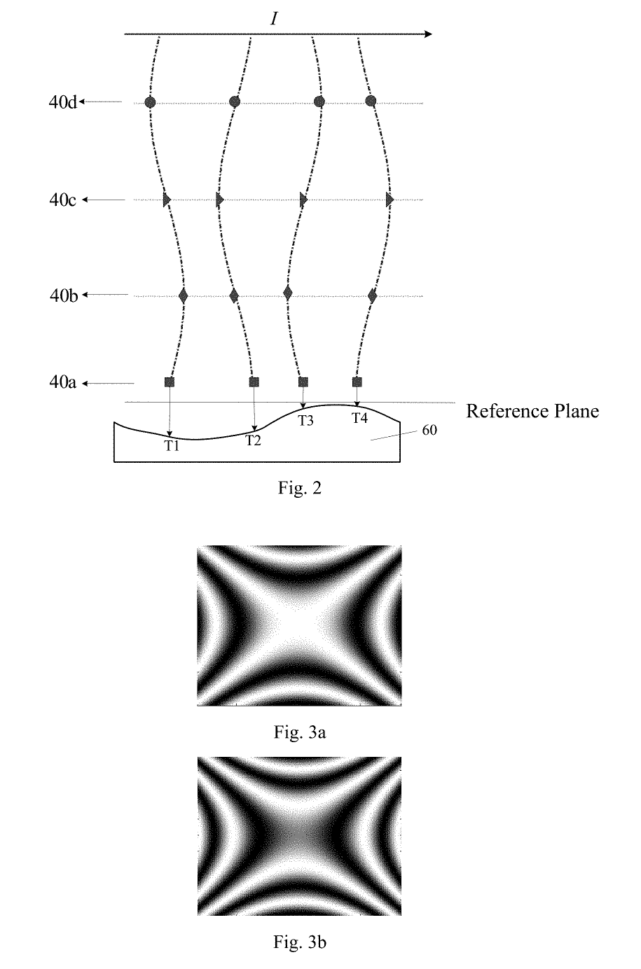

Now referring to FIG. 2, in which interference signals generated at the surface of the detector 50 after the sub-beams pass respectively through the four phase-shift plates 40a, 40b, 40c, 40d are respectively represented by solid squares, diamonds, triangles and circles. T1 to T4 indicate different surface locations of the target object 60 having distinct heights relative to the reference plane. The interference signals depicted above and in correspondence to the locations are also different from one another. For any location being inspected, φ is obtainable from the intensities Iᵢ (i=1, 2, 3, 4) of the four interference signals generated from the sub-beams according to Eqn. (2), and its height relative to the reference plane can thus be calculated as:

$$h = \frac{ϕ}{2 π} λ \qquad ( 3 )$$

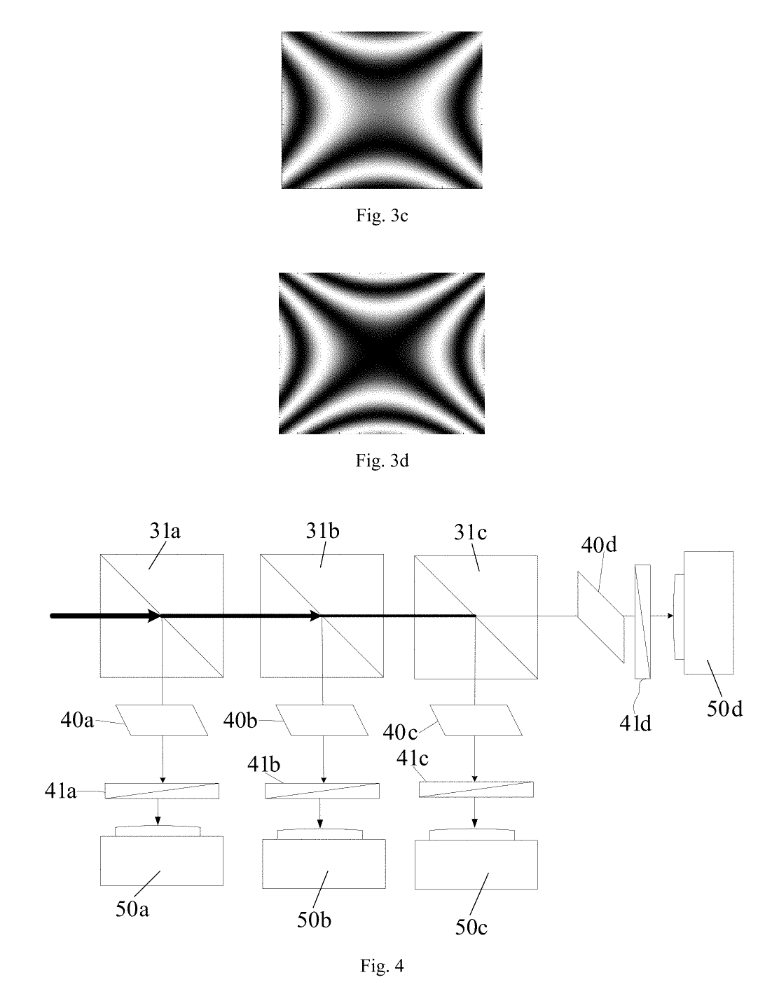

Preferably, in this Embodiment, the detector 50 is a CMOS or CCD sensor. The four planar interference patterns formed at the surface of the detector 50 by the sub-beams that have passed respectively through the phase-shift plates 40a, 40b, 40c, 40d are shown in FIGS. 3a to 3d. Throughout these patterns, pixels at the same position correspond to an individual location in the field of view whose height can be calculated from light intensity values recorded in the four corresponding pixels using the algorithm.

With the 3D surface inspection method according to the present invention, transient acquisition of plurality of interference signals of a surface location of the target object 60 present in the field of view is possible without involving vertical scanning, from which information about height of the surface can be calculated. This, together with the scanning by the motion stage 61, allows rapid 3D surface inspection for the target object 60 with higher efficiency even when it is large in size.

### Embodiment 2

Now referring to FIG. 4, this Embodiment differs from Embodiment 1 in that the multi-beam splitter is made up of n second splitters 31a, 31b, 31c, where n is a positive integer and is set as three in this Embodiment. The three second splitters 31a, 31b, 31c split the light beam into four sub-beams each corresponding to a respective one of phase-shift plates 40a, 40b, 40c, 40d, a respective one of polarization combiners 41a, 41b, 41c, 41d and a respective one of detectors 50a, 50b, 50c, 50d. In other words, compared to Embodiment 1, each sub-beam in this Embodiment is associated with an individual phase-shift plate, an individual polarization combiner and an individual detector. With this configuration, the light-sensitive area of each of the detector 50a, 50b, 50c, 50d can be fully utilized, resulting in expansion of the inspection field of view to four times that of Embodiment 1 and hence improved inspection efficiency.

### Embodiment 3

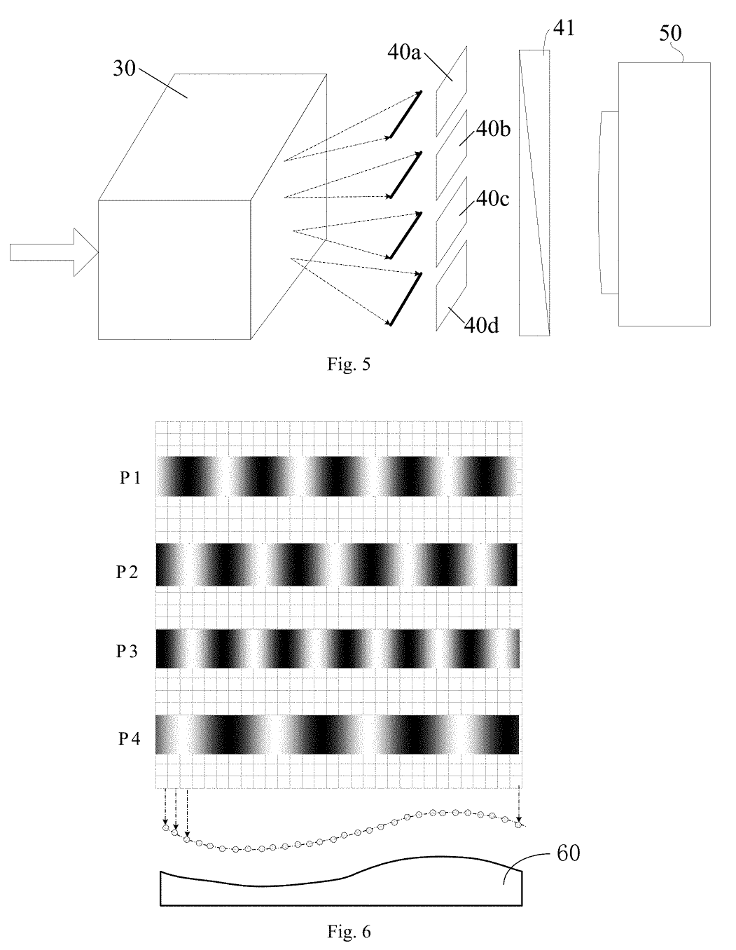

This Embodiment differs from Embodiment 1 in that a linear light source is used. Now referring to FIG. 5, four linear sub-beams from the multi-beam splitter 30 pass through the respective four phase-shift plates 40a, 40b, 40c, 40d as well as the polarization combiner 41 and enter the detector 50. With reference to FIG. 6, the four sub-beams form four linear interference patterns P1, P2, P3, P4 at the surface of the detector 50. Throughout these patterns, light intensity values of each column of pixels correspond to the interference signal for an individual location whose height h can be obtained according to Eqns. (1) and (2). Sequentially processing the columns of pixels allows the obtainment of a height profile along a surface line of the target object 60, as shown in the circle-dotted curve in FIG. 6. According to this Embodiment, rapid 3D surface inspection of a large object can also be achieved without involving vertical scanning.

### Embodiment 4

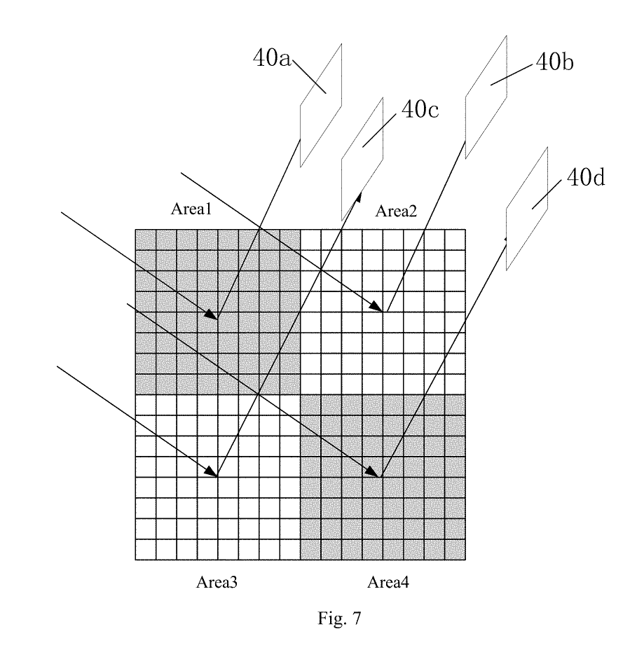

With reference to FIG. 7, this Embodiment differs from Embodiment 1 in that the multi-beam splitter 30 uses a spatial light modulator to split the light beam. In particular, the multi-beam splitter 30 may be divided into four areas Area1, Area2, Area3 and Area4, and four or more sub-beams can be formed by configuring the rotation angles of the four areas Area1, Area2, Area3 and Area4. Each of the sub-beams is directed into a corresponding one of the phase-shift plates 40a, 40b, 40c, 40d. According to this Embodiment, use of the spatial light modulator for light beam splitting enables a more flexible implementation of optical path configuration and formation of more sub-beams.

### Embodiment 5

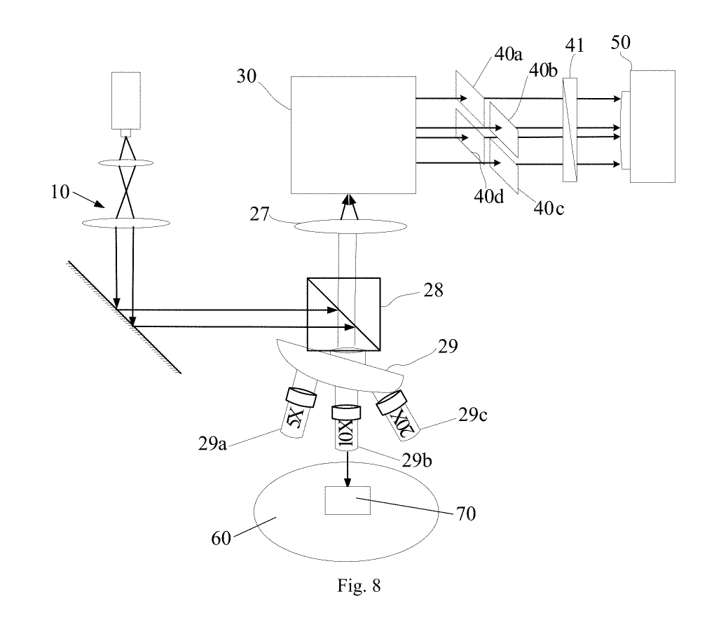

Now referring to FIG. 8, a plurality of interference objectives 29a, 29b, 29c of different magnifications are provided between the illumination unit 10 and the surface of the target object 60. In this Embodiment, the number of the interference objectives 29a, 29b, 29c is three and their magnifications are respectively 5×, 10× and 20×. Preferably, the plurality of interference objectives 29a, 29b, 29c are switchable using a revolving nosepiece 29. A higher magnification results in a smaller inspection field of view 70 as well as a higher horizontal resolution. Preferably, a first splitter 28 is disposed between the light beam from the illumination unit 10 and the interference objectives 29a, 29b, 29c so that the inspection beam can be guided into one of the interference objectives 29a, 29b, 29c.

In summary, the present invention provides an apparatus and method for 3D surface inspection. The apparatus includes, disposed sequentially along the direction of propagation of a light beam, an illumination unit 10, a polarization splitting unit 20, a multi-beam splitter 30, a plurality of phase-shift plates 40a, 40b, 40c, 40d and a detector 50. An inspection beam 101 and a reference beam 102 are formed after the light beam 100 from the illumination unit 10 passes through the polarization splitting unit 20. The inspection beam 101 is incident on the surface of a target object 60 and is reflected by the surface. It then again enters the polarization splitting unit 20. The reference beam 102 is incident on the second reflector 26 and is reflected thereby back into the polarization splitting unit 20 where it is superimposed with the inspection beam 101 from the surface of the target object 60. The superimposition of the inspection beam 101 and the reference beam 102 is divided by the multi-beam splitter 30 into a number of sub-beams each corresponding to one of the phase-shift plates 40a, 40b, 40c, 40d and thereby gains an additional phase difference between the inspection sub-beam and the reference sub-beam which are polarized perpendicular to each other. Thereafter, the sub-beams pass through a polarization combiner 41, making the inspection sub-beams and the reference sub-beams polarized in the same direction and generating interference signals at the surface of the detector 50. The additional phase differences created by each of the phase-shift plates 40a, 40b, 40c, 40d are different from one another. According to the present invention, transient acquisition of plurality of interference signals of a surface location of the target object 60 present in the field of view is possible without involving vertical scanning, from which information about height of the surface can be calculated. This, together with the scanning performed by a motion stage 61, allows rapid 3D surface inspection for target object 60 with higher efficiency even when it is large in size.

It will be apparent to those skilled in the art that various changes and modifications can be made to the invention without departing from the spirit and scope thereof. Accordingly, it is intended that the present invention also include these modifications and variations if they come within the scope of the appended claims and their equivalents.

What is claimed is:

1. A three-dimensional (3D) surface inspection apparatus, comprising, disposed sequentially along a direction of propagation of a light beam, an illumination unit, a polarization splitting unit, a multi-beam splitter, a plurality of phase-shift plates, a polarization combiner and a detector, the light beam from the illumination unit being split by the polarization splitting unit into an inspection beam and a reference beam that are polarized in directions perpendicular to each other, the inspection beam being incident on and reflected by a surface of a target object and entering the polarization splitting unit again, the reference beam being incident on and reflected by a first reflector of the polarization splitting unit and entering the polarization splitting unit again where the reference beam reflected from the first reflector is superimposed with the inspection beam reflected from the surface of the target object, the superimposed inspection beam and reference beam being divided by the multi-beam splitter into a plurality of sub-beams each of which then passes through a corresponding one of the plurality of phase-shift plates and thereby obtains an additional phase difference between an inspection sub-beam and a reference sub-beam contained in the sub-beam, the plurality of sub-beams passing through the polarization combiner, making the inspection sub-beam and the reference sub-beam contained in each of the plurality of sub-beams polarized in a same direction and generating a corresponding interference signal at a surface of the detector, wherein the additional phase differences created by the plurality of phase-shift plates are different from one another.

2. The 3D surface inspection apparatus of claim 1, wherein the illumination unit comprises, disposed sequentially, a light source, a beam collimator/expander and a second reflector; the light beam from the light source passes through the beam collimator/expander and is incident on and reflected by the second reflector; and the light beam reflected from the second reflector is incident on the polarization splitting unit.

3. The 3D surface inspection apparatus of claim 2, wherein the light source is a mercury lamp, a xenon lamp, a halogen lamp or a laser light source.

4. The 3D surface inspection apparatus of claim 2, wherein the beam collimator/expander comprises, disposed sequentially, a first lens and a second lens.

5. The 3D surface inspection apparatus of claim 1, wherein: the polarization splitting unit further comprises a polarization splitter, a first λ/4 plate, a third lens, a second λ/4 plate, a fourth lens and a fifth lens; the light beam from the illumination unit is split by the polarization splitting unit into the inspection beam and the reference beam that are polarized in directions perpendicular to each other; the inspection beam passes through the first λ/4 plate and the third lens and is incident on and reflected by the surface of the target object, and the inspection beam reflected from the surface of the target object passes again through the third lens and the first λ/4 plate with a polarization direction thereof rotated by 90 degrees and further through the polarization splitter and the fifth lens, and is incident on the multi-beam splitter; and the reference beam passes through the second λ/4 plate and the fourth lens and is incident on and reflected by the first reflector, and the reference beam reflected from the first reflector again passes through the fourth lens and the second λ/4 plate with a polarization direction thereof rotated by 90 degrees and is then reflected by the polarization splitter, passes through the fifth lens and enters the multi-beam splitter.

6. The 3D surface inspection apparatus of claim 1, wherein a plurality of interference objectives of different magnifications are disposed between the illumination unit and the surface of the target object.

7. The 3D surface inspection apparatus of claim 6, wherein the plurality of interference objectives are switchable by a revolving nosepiece.

8. The 3D surface inspection apparatus of claim 6, wherein the light beam from the illumination unit passes through the polarization splitting unit and is incident on one of the plurality of interference objectives; and the polarization splitting unit is implemented as a first splitter.

9. The 3D surface inspection apparatus of claim 1, wherein the multi-beam splitter comprises diffraction optical elements for forming a plurality of planar or stripe-like interference patterns at the surface of the detector.

10. The 3D surface inspection apparatus of claim 1, wherein the multi-beam splitter comprises n second splitters which split the superimposed inspection beam and reference beam into (n+1) sub-beams each of which passes through a corresponding one of the plurality of phase-shift plates and a corresponding polarization combiner and is incident on a corresponding detector, where n is a positive integer.

11. The 3D surface inspection apparatus of claim 1, wherein the detector is a CMOS sensor or a CCD sensor.

12. The 3D surface inspection apparatus of claim 1, wherein the multi-beam splitter comprises a spatial light modulator.

13. A three-dimensional (3D) surface inspection method comprising:
formation of an inspection beam and a reference beam by passing a light beam from an illumination unit through a polarization splitting unit, the inspection beam and the reference beam being polarized in directions perpendicular to each other and having a phase difference, the inspection beam carrying surface height information of a target object;
superimposition of the inspection beam and the reference beam;
splitting of the superimposed inspection beam and reference beam into a plurality of sub-beams each of which then passes through a corresponding one of a plurality of phase-shift plates such that an additional phase difference is created between an inspection sub-beam and a reference sub-beam contained in the sub-beam, which results in generation of a plurality of interference signals at a surface of a detector, wherein the additional phase differences created by the plurality of phase-shift plates are different from one another; and
acquisition of the surface height information of the target object based on the plurality of interference signals generated at the surface of the detector.

14. The 3D surface inspection method of claim 13, wherein the acquisition of the surface height information comprises calculating a height relative to a reference plane according to:
$$h = \frac{ϕ}{2 π} λ$$
where, λ represents a wavelength of the light beam from the illumination unit, and y denotes the phase difference between the inspection beam and the reference beam.

15. The 3D surface inspection method of claim 14, wherein the superimposed inspection beam and reference beam is divided into four sub-beams, and the phase difference φ is calculated as:
$$ϕ = a c tan ( \frac{{I}_{4} - {I}_{2}}{{I}_{1} - {I}_{3}} )$$
where, I₁, I₂, I₃ and I₄ respectively represent intensities of the interference signals generated by the four sub-beams at the surface of the detector.

16. The 3D surface inspection method of claim 15, wherein four phase-shift plates are used to create an additional phase difference of 0, π/2, π and 3π/2 for the four sub-beams, respectively; and I₁, I₂, I₃ and I₄ are calculated as:
I₁=A+B×cos(φ)
I₂=A+B×cos(φ+π/2)
I₃=A+B×cos(φ+π)
I₄=A+B×cos(φ+3π/2)
where, A and B are constants.
